(19) United States
(12) Patent Application Publication
(10) Pub. No.: US 2012/0126721 A1
(43) Pub. Date: May 24, 2012

(54) GPS-BASED LIGHTING CONTROL SYSTEM

(75) Inventors: Glenn Howard Kuenzler, Beachwood, OH (US); Tomislav Stimac, Concord, OH (US); Mark Mayer, Sagamore Hills, OH (US)

(73) Assignee: Lumination LLC

(21) Appl. No.: 12/906,384

(22) Filed: Nov. 19, 2010

(51) Int. Cl. H05B 37/00

(52) U.S. Cl. 315/312

(57) ABSTRACT

A GPS-based lighting system is provided. The lighting system includes at least one lighting fixture including a light source and a GPS microchip incorporated therein that is configured to detect the geographic location of the at least one lighting fixture, and a control capable of transmitting a signal comprising operating instructions to the at least one lighting fixture. The at least one lighting fixture is configured to respond to operating instructions specific to the geographic location of the at least one lighting fixture.

### BACKGROUND

The following relates to lighting systems and devices, and particularly to lighting systems and devices integrated with GPS technology.

Various systems have been used to control the functioning of lighting units. U.S. 2007/0029949 describes systems that incorporate a motion detector or sensor, wherein lights turn on, off, or are dimmed according to a detected level of motion within the room. U.S. Pat. No. 7,019,276 discloses a system that incorporates a scheduler, which includes a real-time clock to coordinate at what time lights must be turned on and/or off, and also systems that include light sensors for providing a measurement of the overall light level in a particular area, which is then compared to a light level set point. Although such systems are generally effective, such sensors and clocks are prone to errors and variability, which can affect the overall efficiency of the system. Particularly in the context of outdoor LEDs, if used during the day, the LEDs can get overheated by the sunlight, which could cause the entire fixture to fail. Additionally, such systems cannot control lighting function outside detected movement and sunlight, and are therefore of limited utility.

Positional systems have recently been incorporated into various devices to assist in controlling lighting mechanics, such as a mobile phone backlight and vehicle lighting systems. A real-time positional system, Global Positioning Systems (GPS), is widely used as a space-based global navigation system that provides reliable location and time information in all weather and at all times anywhere on earth. GPS comprises three segments: a space segment comprising 24 operating satellites that transmit one-way signals, a control segment that consists of a worldwide monitor and control stations that maintain the satellites in their proper orbits through occasional command maneuvers, and a user segment that consists of the GPS receiver, which receives the signals from the GPS satellites and uses the transmitted information to calculate a user's three dimensional position and time.

JP Patent Laid-Open No. 2-296550 illustrates one example of the implantation of GPS in vehicles to control light distribution, wherein the distribution of light according to a road shape is based on information from a navigation apparatus. U.S. 2006/0172745 describes the incorporation of GPS in non-automotive fields, such as in a mobile electronic device, wherein the GPS controls the display backlight based on positional data.

Recently, GPS has been implemented into general lighting systems as a way of controlling lighting functions. For instance, U.S. 2007/0091623 discloses a plurality of luminaire managers that monitor the status of their respective luminaries and may include a GPS for locating the position of a luminaire manager. Additionally, the GPS if used to determine if coordinates differ from what is expected to detect is a luminaire was installed improperly or has been removed. U.S. Pat. No. 7,659,676 provides a lighting system that implements a GPS receiver for calculating sunrise and sunset times and providing such information to a controller that turns a light on and off according to such times.

Notwithstanding these systems, there remains a need for an improved light management system that is able to control one or more lighting fixtures based solely on geographical location, independent of sunrise and sunset times.

### BRIEF SUMMARY

According to one aspect of the present disclosure, a GPS-based lighting system is provided. The lighting system includes at least one lighting fixture including a light source and a GPS microchip incorporated therein that is configured to detect the geographic location of the at least one lighting fixture, and a control capable of transmitting a signal comprising operating instructions to the at least one lighting fixture. The at least one lighting fixture is configured to respond to operating instructions specific to the geographic location of the at least one lighting fixture.

According to another aspect of the present disclosure, a method of controlling the operation of lighting fixtures is provided. The method includes providing at least one lighting fixture including a light source and a GPS microchip, transmitting the GPS coordinate zone to a control system, broadcasting a signal from the control system to the lighting fixture specifying at least one coordinate zone, and receiving the signal by the at least one lighting fixture. The GPS microchip provides the at least one lighting fixture with its precise GPS coordinate zone.

According to yet another aspect of the present disclosure, a method of geographically controlling a plurality of lighting fixtures is provided. The method includes providing each of the plurality of lighting fixtures with a light source and a GPS microchip, identifying the geographic coordinate location of the lighting fixture based on information provided by the GPS microchip, providing the lighting control system with operating instructions specific to the particular geographic coordinate location, and broadcasting a signal, including the operating instructions, to each of the plurality of lighting fixtures, Only the lighting fixtures possessing the particular geographic coordinates carry out the operating instructions.

### BRIEF DESCRIPTION OF THE DRAWINGS

The invention may take form in various components and arrangements of components, and in various process operations and arrangements of process operations. The drawing is only for purposes of illustrating embodiments and is not to be construed as limiting the invention.

FIG. 1 illustrates an exemplary GPS-based lighting system according to one aspect of the present disclosure;

FIG. 2 is a flowchart illustrating an operation of the GPS-based lighting system; and

FIG. 3 illustrates an exemplary GPS-based lighting system in a parking lot for guiding parking and lighting walkways.

### DETAILED DESCRIPTION OF PREFERRED EMBODIMENTS

A lighting system is provided that includes at least one lighting fixture with a light source. The lighting fixtures described herein may be outdoor lighting fixtures such as, for example, a lamp post, lantern, street light, flood light, beacon lights, security lights, entry lights, accent lights, and the like. Although this application will be described generally in terms of street lighting, it should be appreciated that the lighting systems contemplated herein may be implemented into various types of indoor and outdoor lighting fixtures alike. Generally, a street light is a raised light source at the edge of a road or parking lot that is primarily used to light dark areas to prevent accidents and increase safety. However, street lights may additionally be used for non-traditional purposes, such as to create a path, provide parking guidance, indicate an emergency or severe weather, or to mark a location.

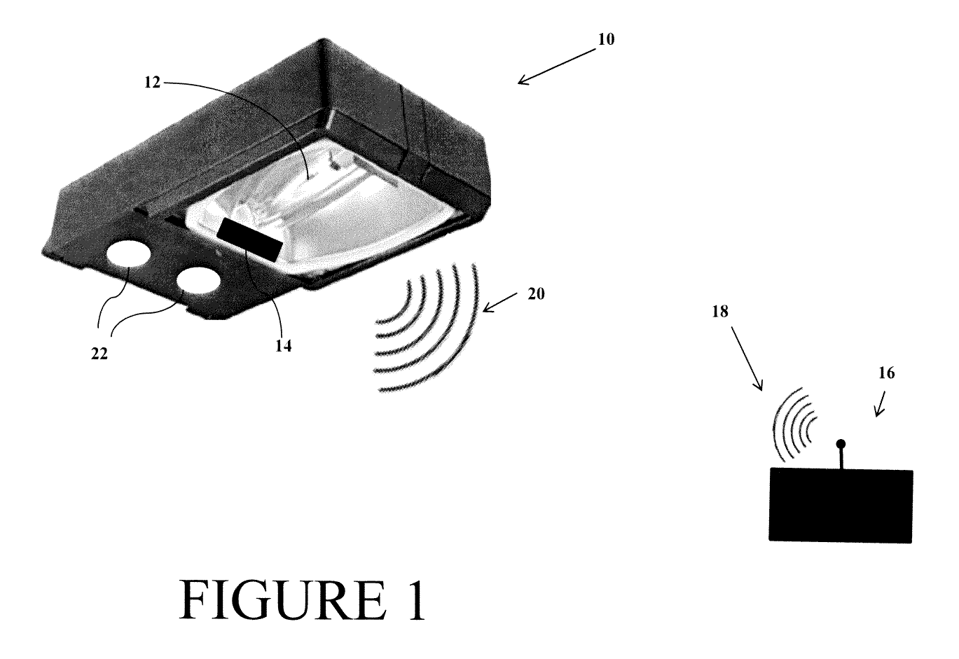

As best illustrated in FIG. 1, a lighting system 10 is provided that includes a light source 12 and incorporates Global Positions System (GPS) technology into the local electronics of the lighting fixtures, with the addition of a GPS microchip 14. GPS microchips may be implemented into existing lighting fixture by a number of know methods, such as soldering the chip onto the fixture control board. The lighting system 10 further includes a lighting control 16 to enable both remote and automated adjustment and control of the lighting fixture 10, which may be separate from or integrated into the lighting fixture. Although the application describes the positional system in terms of GPS, other positional systems may be implemented such as, for example, MLS (Microwave Landing Systems, GSM (Global System Mobile), GIS (Geographical Information Systems, and CPS (Cambridge Positioning Systems).

The lighting control 16 is implemented for broadcasting instructions 18 to either a single light fixture, or a plurality of grouped or otherwise associated light fixtures. The implementation of a GPS microchip 14 in a lighting fixture 10 allows the fixture to effectively know its location, and broadcast this location 20 to the lighting control 16, which would then allow for strategic and specific control of the light fixture 10 from any location. For example, a lighting control can broadcast instructions to all fixtures capable of receiving the signal and only the fixtures included in a specific GPS coordinate zone would carry out the transmitted instructions. The broadcast signal can instruct the fixtures to turn on, turn off, dim, flash, change color, etc., depending on the desired lighting purpose.

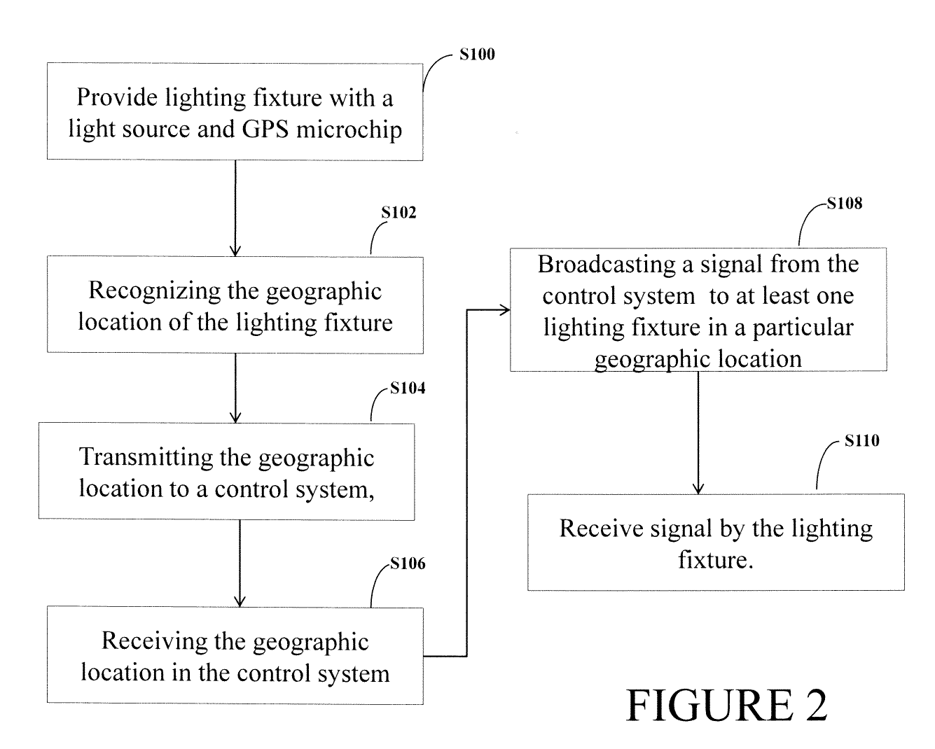

The GPS-based lighting system operates based on signals broadcasted and received by the lighting fixture and the lighting control, as illustrated in FIG. 2. An LED lighting fixture is provided with a GPS microchip (S100) that is capable of recognizing and processing the geographic location of the lighting fixture (S102). The GPS microchip then transmits the location to an associated control system (S104) that can receive and process the geographic location (S106). The control system then broadcasts a signal with operating instructions that may reach any number of lighting fixtures (S108), which are each capable of receiving the signal (S110). However, only the lighting fixtures that are located within the geographic location specified in the operating instructions will respond to the instructions and operate accordingly.

With further reference to FIG. 1, the lighting system may additionally include one or more sensors 22 capable of detecting the status of a lighting fixture 10 and/or specific details pertaining to the environment the fixtures inhabit. For example, the sensors 22 may detect whether a lamp is on or off, if a lamp is functioning properly, light levels from the sky, the amount of precipitation, if any, in the air, sound or noise level, etc. The microchip 14 may then be configured to broadcast this information to the lighting control 16, which would enable even more precise control over the lighting fixtures 10 of the present lighting system.

The GPS microchip 14 also provides the fixture with internal knowledge of the local sunrise and sunset times, such that it could be programmed to turn on and off intelligently without a daytime sensor that could be prone to errors and variability. Compared to local clocks and light sensors, the GPS allows for additional flexibility of lighting control design and reduces control dependency. The GPS creates “smart” fixtures that can gain knowledge about their surroundings and enable a wide network lighting control system, since the fixture listens when a broadcast is transmitted and reacts only to the instructions that apply to its specific or general coordinate location.

The lighting system contemplated herein provides the benefit that the signals broadcasted from the lighting controls do not need to be specifically dedicated to a particular lighting fixture, and can rather be generally broadcasted to all light fixtures that are designed to accept such a signal. However, only the particular fixtures that meet the coordinate criteria will respond to the signal and those that do not will remain unaffected. For example, parking lots may include perimeter lights that are only required to be on during special events. The GPS-based lighting system will transmit a signal to all light fixtures that can pick up such a signal, and only those specific lights within a specified GPS zone will respond to the signal and be activated.

One concern when implementing such a broadcasted signal is the risk of multiple lighting controls sending multiple commands to the same geographically specified lighting fixtures, if such a situation was not desired. For instance, a first lighting control broadcasts a signal to a particular group of lighting fixtures in a parking lot, causing the lights to turn on. It would be undesirable for another control to then broadcast a signal to the same lighting fixtures accidentally causing the lights to turn off, flash, change color, etc. Accordingly, a security measure may be implemented that utilizes an initialization procedure that assigns a code to each fixture or group of fixtures. Typically, this is accomplished with a special remote controller that is brought within a close vicinity of a particular module, or group of modules, that is used to create a code, which the modules then remembers as its “name”. Subsequently, when a control sends out a broadcast signal instructing certain modules to turn on, the individual modules look for their “name” in the broadcast signal. According to the present disclosure, however, the individual fixtures do not need a “name”, since they are taking action based on the broadcast signal the specifies a current GPS position. However, such a security measure may be implemented by including a security code word in the broadcast. If someone intentionally or accidently tries to activate a particular set of fixtures that are not otherwise authorized to receive a signal from the particular control and did not include the proper code word, the fixtures would not respond.

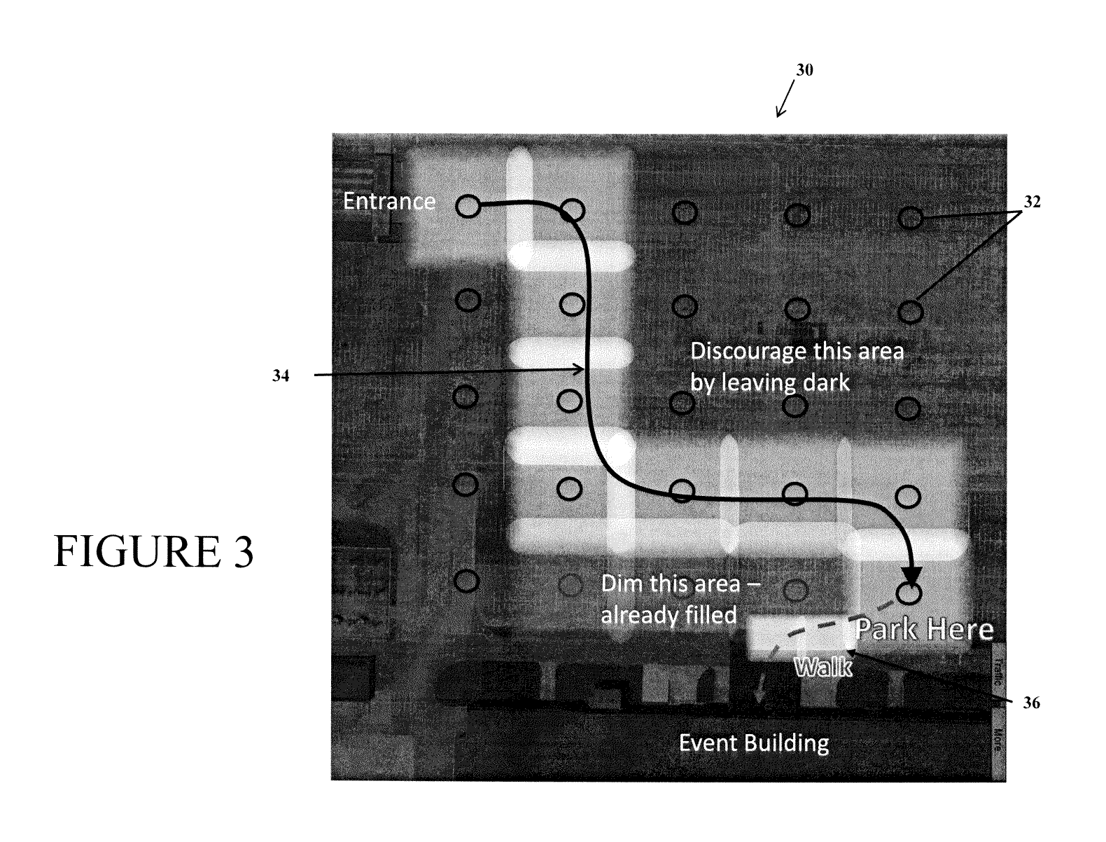

According to the illustration in FIG. 3, a parking lot 30 may include many different phases, such as the back, the middle, and the front of the parking lot, and it might be preferred to fill the phases according to a location preference or in a particular order. The GPS-based lighting system can transmit a signal instructing only the light fixtures 32 in certain phases of the parking lot 30 to turn on and guide visitors to a desired parking area. As the parking lot 30 fills, the activated lighting shifts to guide visitors into different parking phases. Such shifting can occur by dimming the lights in areas that are full and brightening area that remain available for parking, although other designations such as changing colors, etc. are also contemplated. Areas in which parking is to be avoided may be left dark. The lights can additionally be instructed to illuminate a path 34 to guide visitors to an available parking spot. The lighting system may signal when and where a visitor is to turn based on distinguishing feature, such as brightness, color, flashes, etc. Once the vehicle is parked, the lights along a walkway 36 to a visitor's destination may be strategically illuminated to ensure a visitor 1) can easily find the way to a destination, and 2) reach the destination safely and comfortably.

According to yet another example, the GPS-based lighting system provides the ability to provide emergency lighting in times of severe weather, a traffic accident, an Amber Alert, or other such emergency situations. For instance, if there is severe weather approaching a part of town, such as a tornado or hurricane, the lighting control can broadcast instructions for the lights within a certain GPS-zone to change color or flash. Similarly, the lighting control can issue Amber Alerts via lighting signals to reach out to more individuals than can be accomplished by the internet, radio and/or television alone.

The GPS-based lighting system may further be used as a guide to lead ambulances, fire trucks, police vehicles, city maintenance crews, and the like to a specific place that help is needed. This is particularly important since many such vehicles do not include separate GPS devices and such vehicles may have difficulty finding obscure and unfamiliar locations.

Modifications, alterations, and combinations will occur to others upon reading and understanding the preceding detailed description. It is intended that the invention be construed as including all such modifications and alterations insofar as they come within the scope of the appended claims or the equivalents thereof.

What is claimed is:

1. A GPS-based lighting system, comprising:
at least one lighting fixture including a light source and a GPS microchip incorporated therein, said GPS microchip configured to detect the geographic location of said at least one lighting fixture; and
a control capable of transmitting a signal comprising operating instructions to said at least one lighting fixture, wherein said at least one lighting fixture is configured to respond to operating instructions specific to its geographic location.

2. The GPS-based lighting system according to claim 1, wherein said system includes a plurality of lighting fixtures.

3. The GPS-based lighting system according to claim 1, wherein said light source is configured to at least turn on and off in response to said instructions.

4. The GPS-based lighting system according to claim 1, wherein the light source is an LED.

5. The GPS-based lighting system according to claim 1, wherein the GPS microchip is further configured to broadcast information to said control, and said control is capable of receiving said information from said GPS microchip.

6. The GPS-based lighting system according to claim 5, wherein the information includes at least one of geographic location, light status, sunlight detection, and sound detection.

7. The GPS-based lighting system according to claim 1, wherein light source is configured to at least one of turn on, off, and dim in response to said instructions.

8. The GPS-based lighting system according to claim 1, wherein said light source is configured to flash in response to said instructions

9. The GPS-based lighting system according to claim 1, wherein said light source is configured to change color in response to said instructions.

10. The GPS-based lighting system according to claim 1, further comprising at least one sensor capable of detecting the status of said at least one lighting fixture's environment.

11. The GPS-based lighting system according to claim 1, wherein said at least one lighting fixture is configured to indicate the location of an emergency in response to said instructions.

12. The GPS-based lighting system according to claim 1, wherein said at least one lighting fixture is configured to indicate severe weather in response to said instructions.

13. The GPS-based lighting system according to claim 1, wherein said system is provided in a parking lot having multiple lighting fixtures configured to selectively turn on and off in response to said instructions for creating a parking guide.

14. A method of controlling the functioning of lighting fixtures; said method comprising:
providing at least one lighting fixture with a light source and a GPS microchip, wherein said GPS microchip provides said at least one lighting fixture with a geographic location;
transmitting said geographic location to a control system;
broadcasting a signal from said control system to said at least one lighting fixture; and
receiving said signal by said at least one lighting fixture.

15. The method according to claim 14, wherein said signal includes operating instructions.

16. The method according to claim 15, wherein lighting fixtures within at least one specific geographic location carry out said operating instructions.

17. The method according to claim 16, wherein said operating instructions include at least one of turning said light source on, off, dimming said light source, flashing said light source, and changing the color of said light source.

18. The method according to claim 14, wherein said control system is remote from said lighting fixture.

19. The method according to claim 14, wherein said control system is integrated into said at least one lighting fixture.

20. The method according to claim 14, wherein said GPS microchip further provides said at least one lighting fixture with internal knowledge of the precise sunrise and sunset times at said geographic location.

21. A method of geographically controlling a plurality of lighting fixtures, said method comprising:
providing each of said plurality of lighting fixtures with a light source and a GPS microchip;
identifying the geographic location of said lighting fixture based on information provided by said GPS microchip;
providing said lighting control system with operating instructions specific to particular geographic location; and
broadcasting a signal, including said operating instructions, to each of said plurality of lighting fixtures, wherein only the lighting fixtures possessing said particular geographic location carry out said operating instructions.

22. The method according to claim 21, further including transmitting information from said GPS microchip to said control system, and receiving said information by said control system.

23. The method according to claim 21, wherein said operating instructions include at least one of turning a light source on, turning said light source off, dimming said light source, flashing said light source, and changing the color of said light source.

24. The method according to claim 21, wherein carrying out said operating instructions creates an emergency alert lighting pattern.

25. The method according to claim 21, wherein carrying out said operating instructions provides guidance for parking in a parking guidance.

26. The method according to claim 21, further including identifying sunrise and sunset times for the geographic location of said lighting fixture based on information provided by said GPS microchip and operating said lighting fixture based on the identified sunrise and sunset times.
